(19) United States
(12) Patent Application Publication
(10) Pub. No.: US 2026/0062072 A1
(43) Pub. Date: Mar. 5, 2026

(54) COMBINATION, CONNECTION SYSTEM AND METHOD FOR COUPLING A TOWING VEHICLE TO A TOWED VEHICLE

(71) Applicant: Jost - Werke Deutschland GmbH, Neu-Isenburg (DE)

(72) Inventors: Alexander BASTRON, Darmstadt (DE); José Manuel ALGÜERA GALLEGO, Aschaffenburg (DE)

(21) Appl. No.: 19/319,115

(22) Filed: Sep. 4, 2025

(30) Foreign Application Priority Data
Sep. 4, 2024 (DE) 10 2024 125 328.2

(51) Int. Cl. B62D 53/12; B62D 53/08

(52) U.S. Cl. CPC B62D 53/125; B62D 53/0842

(57) ABSTRACT

The present invention relates to a combination, a connection system and a method for coupling a towing vehicle to a towed vehicle.

### CROSS-REFERENCE TO RELATED APPLICATIONS

This application claims the benefit of German Application No. 10 2024 125 328.2, filed Sep. 4, 2024, the disclosure of which is incorporated by reference herein in its entirety.

### FIELD OF THE INVENTION

The present invention relates to a combination, a connection system and a method for coupling a towing vehicle to a towed vehicle.

### BACKGROUND

A combination comprises a towing vehicle and at least one towed vehicle. Examples of towing vehicles are tractor vehicles of a tractor-trailer combination or motor vehicles of an articulated vehicle combination, as well as swap body trucks. Examples of towed vehicles are accordingly semitrailers of a tractor-trailer combination, trailers of an articulated vehicle combination and swap bodies.

A tractor vehicle and a semitrailer form a tractor-trailer combination in which the mechanical coupling system comprises a fifth wheel arranged on the tractor vehicle and a king pin located on the bottom side of the semitrailer, which can be engaged with the fifth wheel and locked. The fifth wheel coupling plate is usually designed with a wedge-shaped entry opening in the direction of travel for coupling the semitrailer, wherein the entry opening has a free installation space with at least one installation space depth that ensures that the king pin can enter and exit the fifth wheel coupling. During coupling, the semitrailer slides on the surface of the fifth wheel coupling plate with respect to its vertical alignment. Lateral guidance is ensured by the king pin, which is positively guided in the entry opening during coupling until it reaches its locking position. A method for coupling a tractor unit and a semitrailer is known from KR 20200060650 A.

Similarly, a motor vehicle and a trailer form an articulated vehicle in which the mechanical coupling system comprises a trailer coupling or pin coupling with a drawbar eye assigned to the motor vehicle and a drawbar with a towing eye assigned to the trailer.

Such combinations are very important for the transport of goods. It is common for a towing vehicle and a towed vehicle not to form a fixed combination, but for a towing vehicle to be connected to different towed vehicles of the same type as required. At the end of a journey, the towing vehicle usually parks the towed vehicle. While the towed vehicle is being loaded or unloaded, the towing vehicle can be used to move another towed vehicle. The towing vehicle and the towed vehicle are therefore regularly connected and disconnected. As a result, there are generally more towed vehicles than towing vehicles. To enable semitrailers to be parked, they are usually equipped with landing gear, which performs the support function when no towing vehicle is coupled to the semitrailer.

Combinations are used both in controlled environments, such as container terminals, and in public environments, i.e., on roads. Conditions in controlled environments are often more strictly defined. There are fewer disruptive influences such as road users who are not part of the goods transport system, uneven surfaces, unexpected road closures, etc. However, the reliability requirements in controlled environments are much higher.

In addition to the mechanical connection, the towing vehicle and the towed vehicle are connected to each other for the transmission of various media, in particular compressed air and electrical energy. In the recent past, data connections between the towing vehicle and the towed vehicle have also become increasingly common. For the transmission of the media, the vehicles often have plugs and sockets to which transmission lines can be attached.

Attaching and removing the transmission lines is a time-consuming task that is often performed manually. This requires a person to climb between the vehicles and handle the lines manually. Apart from the fact that the area between the vehicles is often dirty, there is also a risk of injury. It is therefore desirable to automate the connection of vehicles for the transfer of media such as compressed air, electrical energy, and data.

Two automation systems are known from WO 2022/150720 A2 and U.S. Ser. No. 11,560,188 B2. Both systems are susceptible to environmental influences such as rain or dirt. In addition, it is questionable to what extent the connection shown in FIG. 3c of U.S. Ser. No. 11,560,188 B2 is flexible enough to accommodate movements of the trailer relative to the tractor vehicle on the one hand, and rigid enough to allow the plug connection to be established automatically on the other.

DE 10 2021 209 167 A1 and US 2011/0037241 A1 each disclose a connection system for connecting a tractor with a trailer.

US 2024/0075778 A1 and WO 2019/165147 A1 each disclose a system for connecting gladhand couplings.

### SUMMARY OF THE INVENTION

The invention is intended to improve the automation of the media connection between a towing vehicle and a towed vehicle in a combination and, in particular, to ensure that the connection is reproducible and meets the mechanical requirements of everyday use.

In embodiments, the combination comprises a towing vehicle and a towed vehicle, wherein the towing vehicle and the towed vehicle each have interfaces for transmitting electrical energy, compressed air and/or data. The term “towed vehicle” does not exclude the possibility that the vehicle in question has its own engines for the drive axles.

The combination also comprises a multi-part connection system comprising a first plug unit connected to the interfaces of the towing vehicle and a second plug unit connected to the interfaces of the towed vehicle. An interface can be understood as a component that enables two sections of a conductor to be quickly disconnected and reconnected, such as a plug or a socket. However, an interface may also be present when two parts are permanently connected to each other via a conductor. For example, a control unit of the towing vehicle may be permanently wired to the first plug unit.

The first plug unit can be temporarily connected to the second plug unit to enable the transmission of electrical energy, compressed air, and/or data between the towing vehicle and the towed vehicle.

The combination further comprises a transport device which can move the first plug unit towards the second plug unit in such a way that a plugging operation between the first plug unit and the second plug unit can then take place (transport operation). The transport device is preferably part of the towing vehicle. The combination also comprises a support device which supports the plugging operation between the first plug unit and the second plug unit mechanically, i.e. in particular exerts a force which supports the plugging operation. The support device is preferably partially independent of the transport device. The transport operation and the plugging operation are parts of the overall connection operation of the two plug units. A mechanical device supported by an actuator, in particular a motor, is preferably provided as the support device.

The support device ensures that the plugging operation is completed so that media can be transferred between the vehicles. The support device can be designed to meet the mechanical requirements, in particular if it is provided independently of the transport device.

The plug units preferably have several plug contacts. The plug contacts may be pins and pin receptacles, for example. The pins may be suitable for transmitting electrical energy, compressed air, and data. The plug contacts preferably protrude from a base body of the respective plug unit in one direction. The plug contacts offer resistance to the plugging operation, which must be overcome in order to complete the plugging operation. The plug contacts of a plug unit are preferably grouped together to form a plug group, i.e. they are connected simultaneously to the plug contacts of the other plug unit. This means that it is neither necessary nor possible to connect individual plug contacts to the respective partner on the other plug unit.

In addition to or as an alternative to the plug contacts, the plug units may also have other transmission elements, for example a transmitter and a receiver of a contactless communication system, for example according to WO 2020/016420 A2.

The transport device preferably comprises a handling robot, particularly preferably an articulated arm robot. An articulated arm robot allows the first plug unit to be transported to the second plug unit with particular precision. This ensures that the plug units are correctly positioned for the subsequent plugging operation. The plugging operation can also be performed in part by the transport device. In this case, too, an articulated arm robot is particularly well suited, since an articulated arm robot is capable of applying a certain plugging force and exerting it in a predetermined direction.

The transport device is preferably temporarily connected to the first plug unit and can be detached from it. This enables the transport device to move away from the first plug unit after the plugging operation, for example into a standby position. This inhibits the transport device from being damaged during travel. In particular, the first plug unit has a holder and the transport device has a gripper for gripping the holder. This ensures that the transport device can repeatedly grip the first plug unit securely and then transport it to or away from the second plug unit. The gripper and the holder are preferably connected to each other in a form-fitting manner when holding.

The support device is preferably formed by parts of the first plug unit and parts of the second plug unit, which together support the plugging operation mechanically. Advantageously, the parts cooperate in such a way that they pull the first plug unit and the second plug unit together in a plug direction. In preferred embodiments, the support device comprises two complementary threaded parts and a motor, wherein the motor can rotate at least one of the threaded parts. When the transport device moves the first plug unit toward the second plug unit, i.e., brings the plug units together, the complementary threaded parts are brought into contact with each other. If one of the threaded parts is then rotated, the threaded parts are moved translationally relative to each other. If one of the threaded parts is arranged on the first plug unit and the second threaded part is arranged on the second plug unit, the plug units are ultimately moved toward each other in this manner. This supports the plugging operation mechanically. The threaded parts are preferably a threaded pin and an internal threaded part. The internal threaded part is particularly preferred to be a pin with an internal thread, wherein the internal thread is complementary to the threaded pin. The motor can be, for example, an electric motor or a pneumatic motor. The threaded pin, pin, and plug contacts are preferably all parallel. The threaded parts can also be a pinion and a rack.

The support device can also comprise a lever which is attached to a plug unit and can be brought into engagement with the other plug unit or a part connected thereto in such a way that the plugging operation is supported mechanically by a subsequent deflection of the lever. Due to the lever, a large plugging force can then be exerted with less force. The lever is in particular a toggle lever or a deflection lever.

The pin preferably protrudes further from the base body of the associated plug unit in the plug direction than all plug contacts of this plug unit. This ensures that the pin is the first part of the respective plug unit to come into contact with the other plug unit. This supports the plugging operation mechanically at an early stage and over the entire length of the plug contacts.

In advantageous embodiments, the threaded pin runs in a bore whose inner diameter is greater than an outer diameter of the threaded pin, and an outer diameter of the pin essentially corresponds to the inner diameter of the bore. The threaded pin is thus protected from the ambient conditions. The pin and threaded pin can still be easily brought together, as the pin can be pushed into the bore during the plugging operation.

At least one of the threaded parts preferably has a centering aid at the end, particularly preferably a centering chamfer or centering tip. This is particularly advantageous for both threaded parts. A centering aid supports the coming together of the threaded parts. Due to inaccuracies in manufacture or assembly, as well as wear, the threaded parts may not run strictly in the plug direction. A centering aid ensures that the respective parts can be effectively brought together despite these inaccuracies.

In advantageous embodiments, at least one of the threaded parts is displaceable along the plug direction and spring-mounted. This cushions the impact of the two threaded parts and also ensures that the threaded parts are pressed against each other even after impact, thus ensuring that the threaded parts can engage effectively as soon as one of the two is turned. In addition, the movable bearing can also be used to detect the presence of the other plug unit. For this purpose, a sensor is preferably provided which detects a position of the threaded part along the plug direction and preferably transmits a signal to a control unit when a predetermined position is reached. Once the predetermined position is reached, the motor can be controlled, for example, in such a way that it rotates one of the threaded parts. This ensures that the motor only rotates when the two threaded parts are firmly against each other. This reduces energy consumption and inhibits premature wear of the threaded parts.

Alternatively or additionally, a sensor may be provided which detects a relative position of the plug units along the plug direction and preferably transmits a signal to a control unit when a predetermined position is reached. Once the target position has been reached, the motor can be controlled, for example, so that it rotates one threaded part. The sensor preferably comprises a sensor element which is arranged on a plug unit and is designed to detect an element of the other plug unit. The sensor is preferably attached to the plug unit on which the motor is arranged. This allows easy control of the motor. The sensor is preferably arranged on the first plug unit, since it can be supplied with energy there by the towing vehicle.

The sensor element is preferably a Hall sensor, an inductive sensor, a reed sensor or an optical sensor, for example a photocell. The element detected by the sensor element may be an additional element whose main function is to be detected by the sensor element. However, the sensor element can also be designed and arranged in such a way that it detects an existing part of a plug unit, for example the pin. The element to be detected is preferably adapted to the sensor element, for example in the form of a magnet for the reed sensor or in the form of a metal part for the inductive sensor.

The sensor element can, for example, be arranged in the front wall of the plug unit. This allows the plug units to be detected early on when they come into contact with each other.

It is advantageous if the motor is used on the side of the towing vehicle. The reason for this is that there are generally fewer towing vehicles than towed vehicles in a vehicle fleet. Some of the towed vehicles are therefore standing around passively. If the motor is used on the towing vehicle, fewer motors need to be purchased overall, which reduces the total cost of a fleet.

In advantageous embodiments, the motor and one of the threaded parts are permanently attached to the first plug unit. This enables a compact design of the support device. In other advantageous embodiments, it is envisaged that the motor is attached to the transport device and one of the threaded parts is attached to the first plug unit, and that the first plug unit has a coupling by means of which the motor can exert a torque or a force on the threaded part. This allows the first plug unit to be made smaller, so that it protrudes less from the towed vehicle when it is arranged there. The coupling can, for example, be a form-fitting square connection. Alternatively or in addition to threaded parts, other support devices can also be provided. For example, it is possible to provide a pneumatic cylinder which is attached to one of the plug units and is coupled to the other plug unit when it approaches, in particular by means of a positive connection (hooking). When the cylinder is then retracted, the plug units are pulled together. Alternatively or additionally, switchable magnets can be used to support the plugging operation mechanically. A switchable magnet (electromagnet) comprises a coil which is selectively connected to or disconnected from an energy source. When the coil is supplied with energy, it produces a magnetic field which attracts a metal part of the other plug unit. This can also support the plugging operation mechanically.

To ensure that the plug connection remains secure even while the combination is in motion, advantageous embodiments provide a locking device which inhibits the first plug unit from being separated from the second plug unit after the plugging operation. The locking is preferably formed by the threaded parts being self-locking and/or by the locking comprising latching elements. The latching elements are preferably latching elements which offer a surmountable resistance in the plug direction and against the plug direction. The resistance is preferably dimensioned such that it can be overcome by the support device, but is at the same time sufficiently large to withstand vibrations that normally occur during travel. Alternatively or additionally, an unlocking device may be provided which can overcome the locking. In this case, the resistance of the locking device can be selected to be greater, which provides greater protection against vibrations and the like. The locking and unlocking devices can also be combined in an assembly, for example by means of a mechanical bolt or an electromagnetic lock which is selectively activated (locking) and can then be deactivated (unlocking).

In order to protect the plug contacts from environmental influences when they are plugged together, advantageous embodiments provide that the first plug unit and/or the second plug unit comprise a housing. The housing preferably has a cross-section that is complementary to the other plug unit. This allows the housing to be designed compactly. In order to compensate for manufacturing tolerances and wear, the housing preferably has guide elements (ramp tabs) at the ends, which are arranged in a funnel shape. The guide elements guide the other plug unit during the plugging operation or even before. This also makes the plugging operation more reliable.

The housing is preferably open at the bottom, in particular exclusively open at the bottom. This provides particularly good protection for the interior of the housing and everything inside it from rain. However, the downward opening means that the plugging operation is carried out vertically upwards, which would not be advantageous in itself, as gravity provides additional resistance to the plug direction. However, the support device also allows a plugging operation vertically upwards to be carried out without any problems.

In order to protect the plug contacts and, if necessary, other elements such as the threaded parts from environmental influences before the start of the plugging operation and, in particular, during transport of the first plug unit to the second plug unit, it is advantageous in embodiments that the first plug unit and/or the second plug unit has a cover for the plug contacts, wherein the cover can preferably assume a covering state and a clearance state, wherein it covers the plug contacts in the covering state and does not cover the plug contacts in the clearance state. The cover can be actively switched. However, it is preferably provided that the cover automatically changes from the covering state to the clearance state during the plugging operation. For this purpose, the cover can be pivotably mounted and arranged such that the other plug unit engages with it during the plugging operation in such a way that it is pivoted. For this purpose, the plug unit with the cover can, for example, be inserted into a housing of the other plug unit, whereby the cover briefly catches on a housing wall during the plugging operation and is thereby pivoted.

In order to be able to bring the plug units together, it is useful to know at least the relative position of the two. In advantageous embodiments, a locating device is therefore provided by means of which the position of the first plug unit and/or the second plug unit or their relative position can be determined. The location device preferably has a marking, for example a QR code, and a detector, for example a camera, for detecting the marking. The marking is preferably arranged on the first plug unit or the second plug unit. The position of the first plug unit on the towing vehicle is often known. This is particularly the case if the first plug unit is held by an articulated arm robot. In this case, it is particularly useful to attach the identification mark to the second plug unit and the detector to the towing vehicle, in particular to the transport device. The detector can then determine the position or distance to the identification mark and the transport device can then be controlled in such a way that it moves the first plug unit to the second plug unit.

Alternatively, location can be determined by means of transmitter/receiver units, such as RFID elements.

The second plug unit is preferably arranged on a front side of the towed vehicle. This makes it comparatively easy to access and easily reachable by the transport device. Containers are arranged on a substructure of a towed vehicle for transport. It is sometimes not possible or desirable to attach the second plug unit to the container. It is therefore advantageous to attach the second plug unit to a substructure of the towed vehicle. This allows the container to be exchanged without having to remove the second plug unit. The second plug unit can be temporarily attached to the towed vehicle, for example by means of a magnetic connection. However, it can also be permanently attached to the towed vehicle, for example, it can be screwed or welded in place.

The towing vehicle is preferably a terminal tractor and the towed vehicle is preferably a semitrailer. In terminal tractors, the mounting surface behind the cab is larger than in other tractor vehicles, such as conventional semi-trailers. Terminal tractors are used, for example, in container terminals, where they move semitrailers and only travel short distances. Due to the larger mounting surface, terminal tractors are particularly suitable for the invention, since, for example, an articulated arm robot can be accommodated on the large mounting surface.

A fifth wheel is preferably arranged on the mounting surface of the towing vehicle, in particular a height-adjustable fifth wheel. The towed vehicle preferably has a king pin.

Embodiments of the invention can include a connection system as defined in the above description. The connection system comprises a first plug unit that can be connected to the interfaces of the towing vehicle and a second plug unit that can be connected to the interfaces of the towed vehicle. The first plug unit can be temporarily connected to the second plug unit to enable the transmission of electrical energy, compressed air, and/or data between the towing vehicle and the towed vehicle. The connection system also comprises a support device which supports the plugging operation between the first plug unit and the second plug unit mechanically.

Other embodiments of the invention include a method for coupling a towing vehicle to a towed vehicle by means of a mechanical coupling and by means of a multi-part connection system as described above. In this case, the first plug unit is moved to the second plug unit by means of the transport device, and then a plugging operation takes place between the first plug unit and the second plug unit, the plugging operation between the first plug unit and the second plug unit being mechanically supported by the support device. The plugging operation is preferably carried out jointly by the transport device and the support device.

The mechanical coupling by means of the mechanical coupling preferably takes place before the plugging operation between the first plug unit and the second plug unit. This inhibits the towed vehicle and the towing vehicle from moving away from each other during the transport operation or the plugging operation, which could damage the connecting device or other parts of the towing and towed vehicles and delay the connection operation.

In order to protect the transport device from damage and not to impair the maneuverability of the combination, advantageous embodiments provide that the transport device is separated from the first plug unit after the plugging operation or during the plugging operation. After separation, the transport device can be moved into a standby position in which it takes up less space.

A combination without the support device is also disclosed, wherein the plug units and/or the transport device, apart from the support device, are designed as described above. A combination without the transport device is also disclosed, wherein the plug units and/or the support device, apart from the transport device, are designed as described above.

### BRIEF DESCRIPTION OF THE DRAWINGS

The invention is illustrated and explained by way of example with reference to the drawings. The figures listed below are shown in the drawings:

FIG. 1 a combination in a schematic side view

FIG. 2 a connection system in a perspective view in a separated state

FIG. 3 the connection system of FIG. 2 in a perspective view in a connected state

FIG. 4 a first plug unit for the connection system of FIG. 2 in a perspective view

FIG. 5 a representation of the interior of the first plug unit of FIG. 4

FIG. 6 a second plug unit for the connection system of FIG. 2 in a perspective view

FIG. 7 a representation of the interior of the second plug unit of FIG. 6

FIG. 8 the connection system of FIG. 2 in section in a separated state

FIG. 9 the connection system of FIG. 2 in section in a transition state

FIG. 10 the connection system of FIG. 2 in section in the connected state

### DETAILED DESCRIPTION

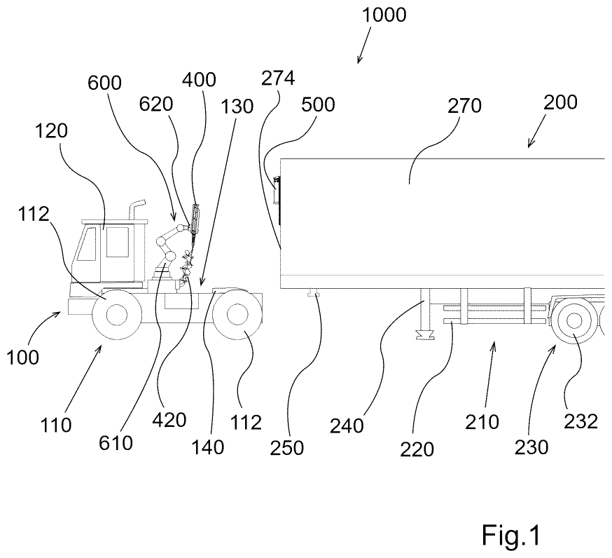

The combination 1000 shown in FIG. 1 comprises a terminal tractor as the towing vehicle 100 and a semitrailer as the towed vehicle 200. Only the front part of the semitrailer is shown.

The towing vehicle 100 comprises an undercarriage 110 with a drive (not shown) and four wheels 112, a driver's cab 120 and a mounting surface 130. The mounting surface 130 is located behind the driver's cab 120. In terminal tractors, the mounting surface 130 is larger than in other tractor vehicles, such as conventional semi-trailer trucks. Terminal tractors are used, for example, in container terminals, where they move semitrailers and only travel short distances. A fifth wheel 140 is arranged on the mounting surface 130 and is height-adjustable.

The towed vehicle 200 has a substructure 210 and a superstructure 270. In the embodiment shown, the superstructure 270 is firmly connected to the substructure 210. The substructure 210 comprises a chassis 220, an undercarriage 230 with wheels 232, a landing gear 240 and a king pin 250. The landing gear 240 is extended.

The king pin 250 is complementary to the fifth wheel 140 and enables mechanical coupling of the towing vehicle 100 and the towed vehicle 200. If a semitrailer is moved by a terminal tractor, the height-adjustable fifth wheel 140 often makes it unnecessary to retract the landing gear 240. After mechanical coupling, the fifth wheel 140 is raised, lifting the trailer with it until the landing gear 240 no longer touches the ground. The combination 1000 can then start moving. Since container terminals and other transshipment points do not usually have any inclines or uneven surfaces to cope with, this procedure is particularly suitable for these applications, as not having to retract the landing gear 240 saves time.

The towing vehicle 100 and the towed vehicle 200 each have interfaces for transmitting electrical energy, compressed air, and data.

The combination 1000 shown in FIG. 1 also comprises a connection system 300 with a first plug unit 400, a second plug unit 500 and a transport device 600, which can move the first plug unit 400 relative to the second plug unit 500 in such a way that a plugging operation can then take place between the first plug unit 400 and the second plug unit 500. The transport device 600 comprises an articulated arm robot 610 with a gripper 620, which is arranged on the mounting surface 130 of the towing vehicle 100.

The gripper 620 is designed such that it can be selectively connected to or disconnected from the first plug unit 400. The first plug unit 400 has a holder 460 for this purpose. The gripper 620 is suitable for gripping the holder 460.

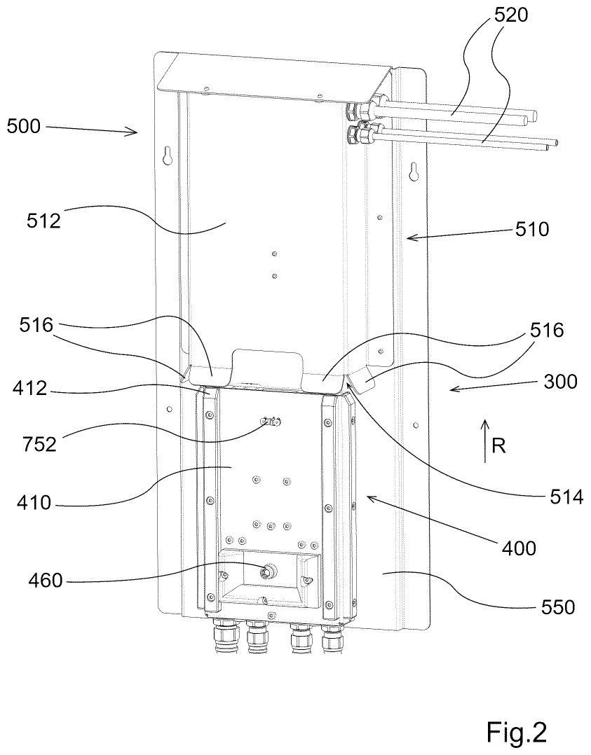

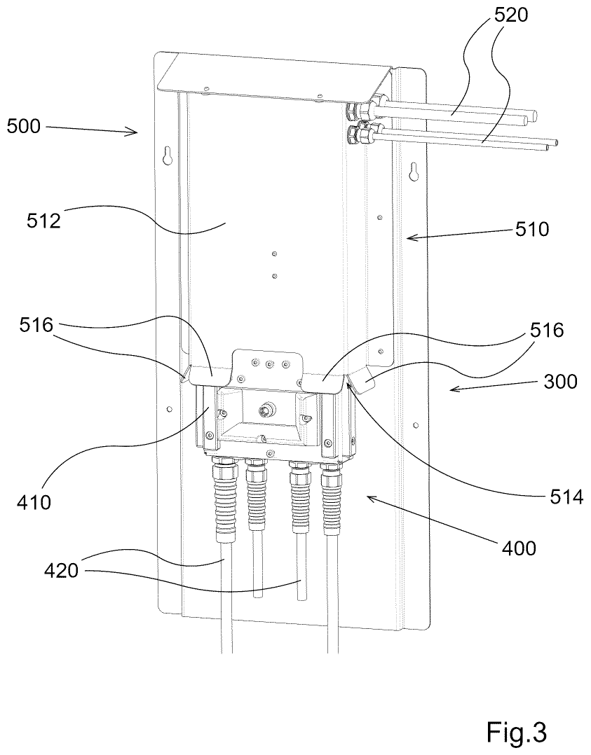

The first plug unit 400 is connected to the interfaces of the towing vehicle 100 via flexible lines 420, and the second plug unit 500 is connected to the interfaces of the towed vehicle 200 via lines 520. The first plug unit 400 is held by the transport device 600. The second plug unit 500 is arranged on a front side 274 of the towed vehicle 200. The first plug unit 400 is a plug and the second plug unit 500 is a socket. The plug units 400, 500 are complementary so that the first plug unit 400 can be temporarily connected to the second plug unit 500 in a connection process to enable the transmission of electrical energy, compressed air and data between the towing vehicle 100 and the towed vehicle 200. To connect the plug units 400, 500, the first plug unit 400 is moved toward the second plug unit 500 in a transport operation (FIG. 2). The plug units 400, 500 are initially still separate. This is followed by a plugging operation in a plug direction R (here vertically upwards), by which the plug units 400, 500 are connected to one another (FIG. 3).

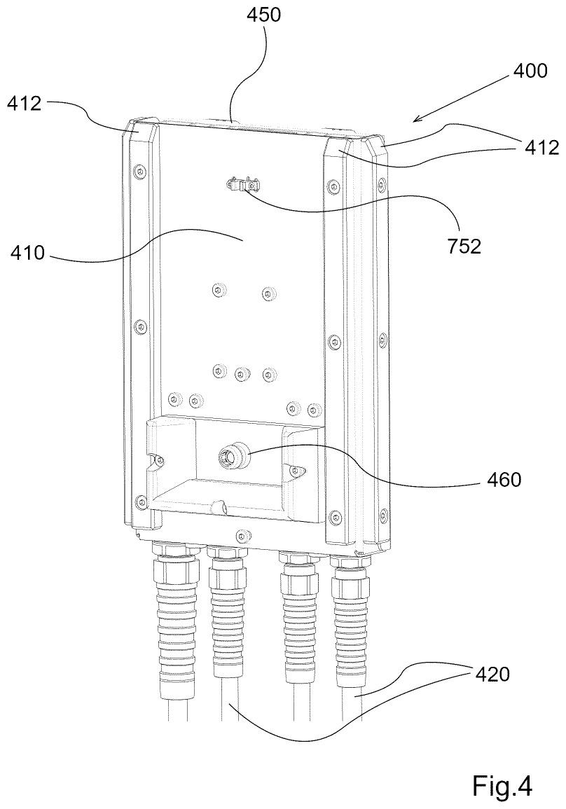

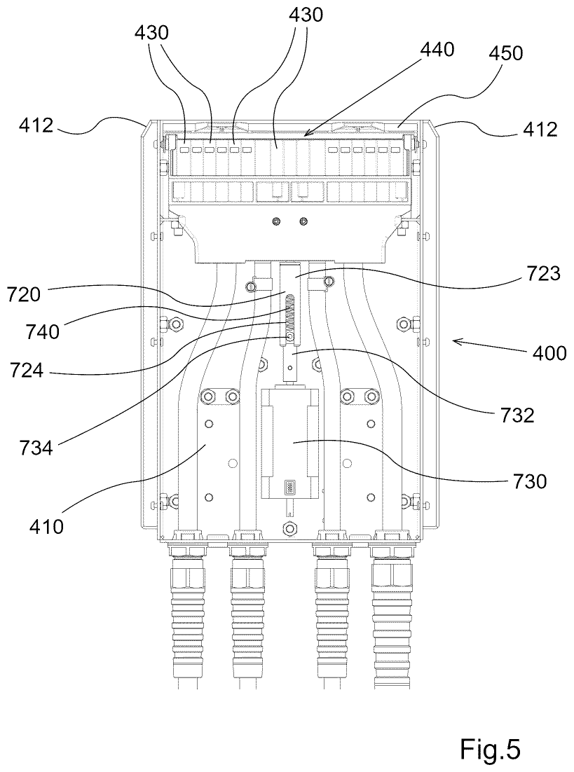

The first plug unit 400 is designed as a plug and comprises a housing 410 with conductors 420 connected thereto (see FIG. 4). The conductors 420 are energy, compressed air, and data lines. The conductors 420 are connected to the interfaces of the towing vehicle 100. The first plug unit 400 also comprises plug contacts 430, which are provided at a front end. The plug contacts 430 are connected to the lines 420 and are each suitable for transmitting at least one medium (energy, compressed air, data) to a complementary plug contact 530 of the second plug unit 500. The plug contacts 430 are combined to form a plug group 440. The plug contacts 530 are combined to form a plug group 540 (see FIG. 5).

At the front end, the first plug unit 400 comprises a cover 450 which can assume a covering state and a clearance state. FIGS. 4 and 5 show the covering state. In this state, the cover 450 covers the plug contacts 430 and thus protects them from environmental influences. To reach the clearance state, the cover 450 must perform a swivel movement.

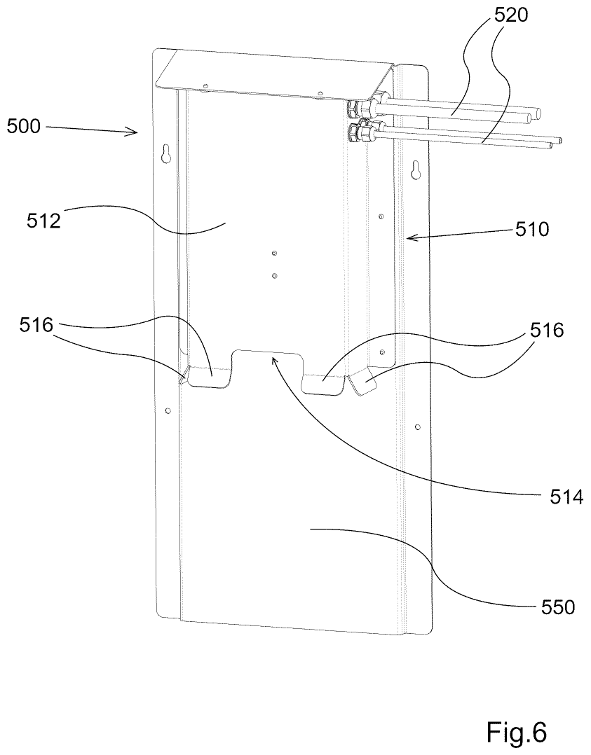

The second plug unit 500 is designed as a plug socket and comprises a housing 510 with conductors 520 connected thereto (see FIG. 6). The housing 510 is open at the bottom so that the first plug unit 400 can be pushed into the housing 510 from below by an upward movement. The housing 410 of the first plug unit 400 comprises guide elements 412 in the form of lead-in chamfers, which assist the insertion of the first plug unit 400 into the housing 510 of the second plug unit 500. The second plug unit 500 comprises a support 550 by means of which the second plug unit 500 can be attached to a towed vehicle (not shown here). The support 550 is a plate which forms part of the housing 510. At the upper end, the plate is angled and forms a projection 560 which closes off the housing 510 at the top. The projection 560 runs at an angle so that rainwater, for example, can run off and does not collect on the projection 560. The housing 510 is further formed by a receiving part 512 which is arranged on the plate and forms a receiving opening 514 for the first plug unit 400 together with the plate. The receiving part 512 has guide elements 516 in the form of guide lugs at the lower end, which assist the insertion of the first plug unit 400 into the second plug unit 500.

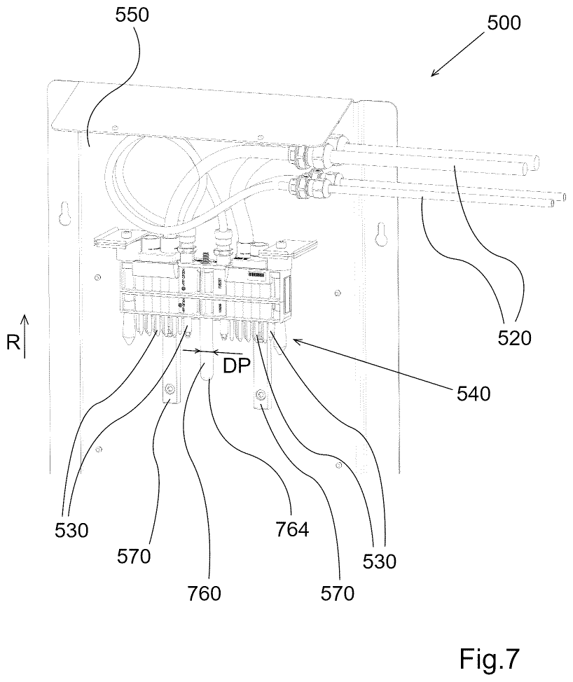

Plug contacts 530 are arranged in the housing 510 of the second plug unit 500 (see FIG. 7). The plug contacts 530 are connected to the conductors 520 and are each suitable for transmitting at least one medium (energy, compressed air, data) to a complementary plug contact 430 of the first plug unit 400. The plug contacts 430 are combined to form a plug group 440. In FIG. 7, the receiving part 512 is not shown.

The plugging operation connects the plug contacts 430 of the first plug unit 400 to the plug contacts 530 of the second plug unit 500 in such a way that energy, compressed air and data can be transmitted.

The plugging operation is mechanically supported by a support device 700. The components of the support device 700 are partially integrated into the first plug unit 400 and partially into the second plug unit 500. On the side of the first plug unit 400, the support device 700 comprises a bore 710, a threaded pin 720, a motor 730, a spring 740, and a sensor 750. On the side of the second plug unit 500, the support device 700 comprises a pin 760.

The threaded pin 720 runs concentrically in the bore 710. Both the bore 710 and the threaded pin 720 run in the plug direction R. The bore 710 is part of the plug group 440 of the first plug unit 400.

The threaded pin 720 has a threaded section 722 in a front region 721 and a groove 724 in a rear region 723. The rear region 723 has a larger diameter than the front region 721. The tip of the front region 721 is chamfered and thus formed as a centering tip 726. The groove 724 runs in the plug direction R. The motor 730 has a motor shaft 732 and a carrier 734 which is arranged in the groove 724. This couples the motor 730 and the threaded pin 720 in such a way that rotation of the motor shaft 732 causes rotation of the threaded pin 720, but at the same time allows relative movement in the plug direction R between the threaded pin 720 and the motor 730. The motor 730 is an electric motor. The spring 740 is arranged between the threaded pin 720 and the motor 730 and causes the threaded pin 720 to be pressed forward by the motor 730. The threaded pin 720 is guided linearly and runs with the rear area 723 against a stop 725, which determines the maximum distance of the threaded pin 720 from the motor 730.

The sensor 750 comprises a sensor element 752 which is attached to the first plug unit 400. A sheet metal plate 754 is arranged inside the housing 510 of the second plug unit 500 and projects into the interior of the housing 510. The sensor element 752 is a Hall sensor. When the plug units 400, 500 are plugged into each other, the sheet metal 754 is moved at a predefined relative position of the plug units 400, 500 through the sensor element 752, which registers this movement or the presence of the sheet metal 754 and transmits a signal to a control unit not shown. When the target position is reached, the motor 730 is controlled in such a way that it rotates the threaded pin 720.

Furthermore, a pin sensor 770 is arranged in the housing 410 of the first plug unit 400. The pin sensor 770 is configured to emit a signal when the threaded pin 720 has been moved against the spring force of the spring 740 in the direction of the motor 730 over a predetermined distance. For this purpose, the pin sensor 770 detects the rear area 723 of the threaded pin 720. The signal can be transmitted to a control unit. This signal can also be used to control the motor 730 in such a way that it rotates the threaded pin 720.

The pin 760 is essentially cylindrical and extends in the plug direction R. The pin 760 is part of the plug group 540 of the second plug unit 500. In contrast to the threaded pin 720, the position of the pin 760 in the second plug unit 500 is fixed. The pin 760 has an internal thread 762 which is complementary to the threaded section 722. At its tip, the pin 760 has an external centering chamfer 764.

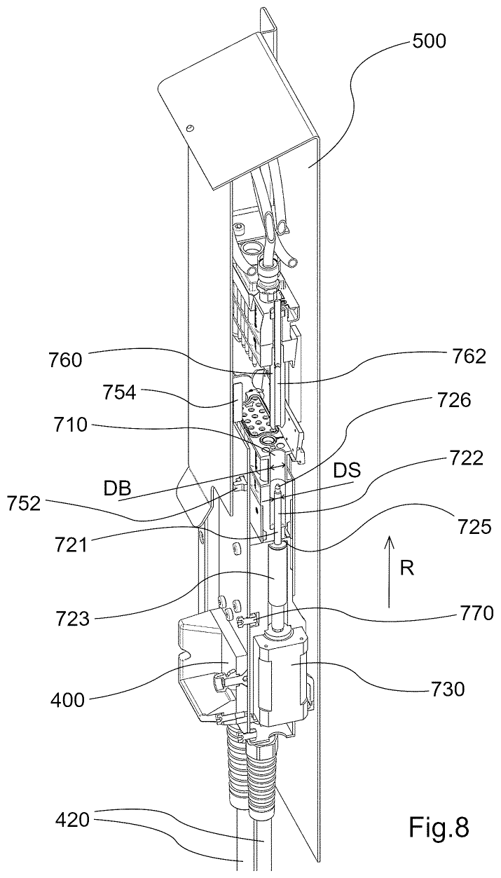

Two rails 570 are also arranged in the housing 510 of the second plug unit 500. The rails 570 run parallel to each other and in the plug direction R. When the first plug unit 400 is pushed into the second plug unit 500, the cover 450 becomes caught on the rails 570 and is thereby opened. The plugging operation is shown in more detail in FIGS. 8, 9 and 10. In FIG. 8, the first plug unit 400 has already been partially pushed into the second plug unit 500. When pushed in, the cover 450 comes into contact with the rails 570 and is thereby pivoted into the clearance state. FIG. 8 shows the state immediately before the plug groups 440, 540 come into contact with each other. If the first plug unit 400 is moved further in the plug direction R, pin 760 enters the bore 710 first. If pin 760 and bore 710 are not completely aligned, the centering chamfer 764 causes pin 760 to be centered in bore 710.

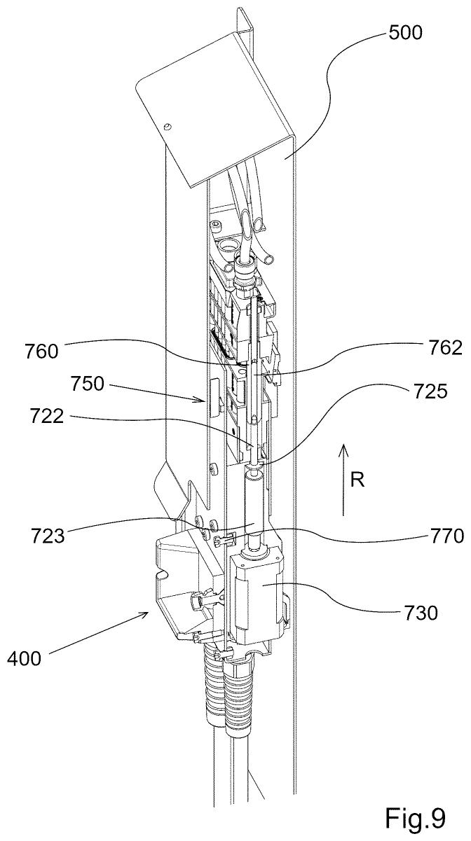

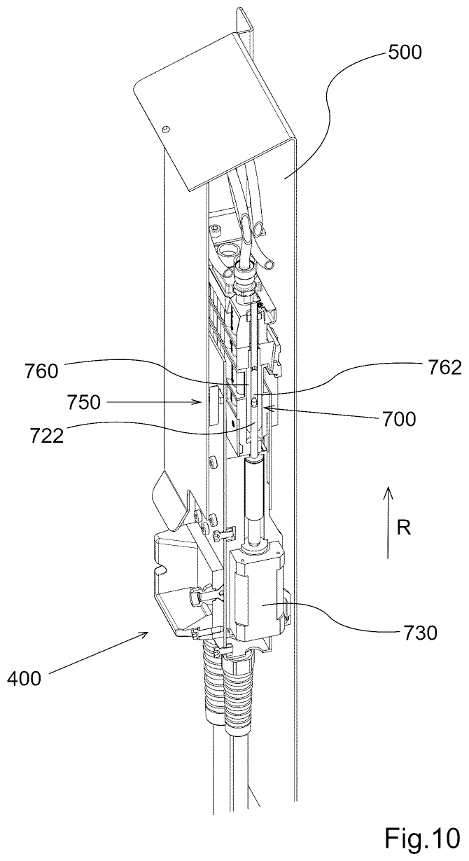

The pin 760 is pushed into the bore 710 by the relative movement of the plug units 400, 500 in plug direction R until it encounters the threaded pin 720. The threaded pin 720 enters the interior of the pin 760 with its centering tip 726, whereby the centering tip 726 causes centering between the pin 760 and the threaded pin 720. A further relative movement of the plug units 400, 500 in plug direction R initially causes the threaded pin 720 to be moved against the spring force of the spring 740, i.e. towards the motor 730 (FIG. 9). This continues until the sensor 770 detects the threaded pin 720 and sends a corresponding signal to a control unit (not shown). When the control unit receives the corresponding signal, it activates the motor 730. The motor 730 then rotates the motor shaft 732, causing the threaded pin 720 to rotate. This rotation causes the threaded section 722 of the threaded pin 720 to be screwed into the internal thread 762 of the pin 760. This initially relieves the spring 740 until the rear section 723 of the threaded pin 720 rests against the stop 725. The plug groups 440, 540 are then pulled together until they are flush with each other (FIG. 10). This connects the plug contacts 430, 530 of the plug units 400, 500 to each other. The motor 730 can then be switched off, for example by a signal from a limit switch (not shown). The plugging operation is then complete.

To separate the plug units from each other, the motor 730 is first operated in the opposite direction. This unscrews the threaded pin 720 from the internal thread 762. Once this has been done, the first plug unit 400 can be moved out of the second plug unit 500 in the opposite direction to the plug direction R. The plug units 400, 500 are then separated from each other.

### LIST OF REFERENCE SYMBOLS

100 towing vehicle
110 undercarriage
112 wheel
120 driver's cab
130 mounting surface
140 fifth wheel
200 towed vehicle
210 substructure
220 chassis
230 landing gear
232 wheel
240 landing gear
250 king pin
270 superstructure
274 front side
300 connection system
400 first plug unit
410 housing
412 guide element
420 conductor
430 plug contact
440 plug group
450 cover
460 holder
500 second plug unit
510 housing
512 receiving part
514 receiving opening
516 guide element
520 conductor
530 plug contact
540 plug group
550 support
560 projection
570 rail
600 transport device
610 articulated arm robot
620 gripper
700 support device
710 bore
720 threaded pin
721 front area
722 threaded section
723 rear area
724 groove
725 stop
726 centering tip
730 motor
732 motor shaft
734 carrier
740 spring
750 sensor
752 sensor element
754 sheet metal
760 pin
762 internal thread
764 centering chamfer
770 pin sensor
1000 combination
DB inner diameter of the bore
DP outer diameter of the pin
DS outer diameter of the threaded pin
R plug direction

1. A combination of a towing vehicle and a towed vehicle,
wherein the towing vehicle and the towed vehicle each have interfaces for transmitting electrical energy, compressed air and/or data,
wherein a multi-part connection system is provided that comprises a first plug unit connected to the interfaces of the towing vehicle and a second plug unit connected to the interfaces of the towed vehicle,
wherein the first plug unit can be temporarily connected to the second plug unit to enable transmission of electrical energy, compressed air and/or data between the towing vehicle and the towed vehicle,
wherein a transport device is provided that can move the first plug unit towards the second plug unit in such a way that a plugging operation between the first plug unit and the second plug unit can subsequently take place,
characterized in that
a support device is provided that supports the plugging operation between the first plug unit and the second plug unit.

2. The combination according to claim 1,
characterized in that
the transport device comprises a handling robot, optionally an articulated arm robot.

3. The combination according to claim 1,
characterized in that
the transport device is temporarily connected to the first plug unit and can be detached from it, wherein the first plug unit has a holder and the transport device has a gripper for gripping the holder.

4. The combination according to claim 1,
characterized in that
the support device comprises two complementary threaded parts and a motor, wherein the motor can rotate one of the threaded parts, wherein the threaded parts are a threaded pin and an internal threaded part, wherein the internal threaded part is optionally a pin with an internal thread that is complementary to the threaded pin.

5. The combination according to claim 4,
characterized in that
the pin protrudes further in the plug direction from a base body of the associated plug unit than all plug contacts of this plug unit.

6. The combination according to claim 4,
characterized in that
the threaded pin runs in a bore whose inner diameter is greater than an outer diameter of the threaded pin,
wherein the outer diameter of the threaded pin essentially corresponds to the inner diameter of the bore.

7. The combination according to claim 4,
characterized in that
at least one of the threaded parts is displaceable along a plug direction and is spring-mounted and/or
at least one of the threaded parts has a centering aid, optionally a centering chamfer or centering tip, at an end thereof.

8. The combination according to claim 1,
characterized in that
a sensor is provided that detects a relative position of the plug units along the plug direction and, optionally, the sensor is configured to transmit a signal to a control unit when a predetermined position is reached.

9. The combination according to claim 4,
characterized in that
the motor and one of the threaded parts are permanently fastened to the first plug unit or
the motor is fastened to the transport device and one of the threaded parts is fastened to the first plug unit and the first plug unit has a coupling by means of which the motor can exert a torque or a force on the threaded part.

10. The combination according to claim 1,
characterized in that
a locking device is provided that inhibits the first plug unit from being separated from the second plug unit after the plugging operation, wherein
a) the locking device is formed by the threaded parts being self-locking and/or
b) the locking device comprises latching elements and/or
c) a release device is provided that can overcome locking of the locking device.

11. The combination according to claim 1,
characterized in that
the support device comprises a pneumatic cylinder that is attached to one of the plug units and is coupled to the other plug unit when it approaches.

12. The combination according to claim 1,
characterized in that
the first plug unit and/or the second plug unit comprises a housing, wherein the housing is open at the bottom and/or the housing has a cross-section complementary to the other plug unit, wherein the housing optionally has guide elements at ends of the housing that are arranged in a funnel shape.

13. The combination according to claim 1,
characterized in that
the first plug unit and/or the second plug unit has plug contacts and a cover for the plug contacts, wherein the cover can assume a covering state and a clearance state, wherein in the covering state it covers the plug contacts and in the clearance state it does not cover the plug contacts.

14. The combination according to claim 1,
characterized in that
a locating device is provided by means of which a position of the first plug unit and/or the second plug unit or their relative position can be determined, wherein the locating device optionally has a marking and a detector configured to detect the marking.

15. The combination according to claim 1,
characterized in that
the second plug unit is arranged on a front side of the towed vehicle.

16. A connection system, comprising: a first plug unit connected to a towing vehicle and a second plug unit connected to a towed vehicle,
wherein the first plug unit can be temporarily connected to the second plug unit to enable transmission of electrical energy, compressed air and/or data between the towing vehicle and the towed vehicle,
wherein a transport device is provided that can move the first plug unit towards the second plug unit in such a way that a plugging operation between the first plug unit and the second plug unit can subsequently take place,
characterized in that
a support device is provided that supports the plugging operation between the first plug unit and the second plug unit.

17. A method for coupling a towing vehicle to a towed vehicle by means of a mechanical coupling and by means of a multi-part connection system according to claim 16, wherein the first plug unit is moved to the second plug unit by means of the transport device and a plugging operation then takes place between the first plug unit and the second plug unit, wherein the plugging operation between the first plug unit and the second plug unit is mechanically supported by the support device, wherein the coupling by means of the mechanical coupling takes place before the plugging operation between the first plug unit and the second plug unit.

18. The method according to claim 17,
characterized in that
the transport device is separated from the first plug unit after the plugging operation or during the plugging operation, wherein the transport device is preferably moved into a standby position after separation, in which it takes up less space.
